(19) United States
(12) Patent Application Publication
(10) Pub. No.: US 2004/0136186 A1
(43) Pub. Date: Jul. 15, 2004

(54) Touch controlled lighting emitting device

(76) Inventor: Ming-Tay Hsu, Tau yuan Hsien (TW)

Correspondence Address: Ming-Tay Hsu, Box 8-24, 235 Chung - Ho, Taipei, TW

(21) Appl. No.: 10/672,995

(22) Filed: Sep. 25, 2003

(30) Foreign Application Priority Data
Jan. 10, 2003 (TW) 092200485

(51) Int. Cl. F21L 4/04

(52) U.S. Cl. 362/208; 362/295; 362/394

(57) ABSTRACT

A touch controlled lighting emitting device is disclosed. A base has a device groove and a hollow battery set. A bottom of the device groove of the base is formed with at least one through hole communicated with the battery groove. A wall of the device groove is formed with at least one axial slot. A wall of the battery groove is formed with at least one axial recess communicated with a respect slot. The long lead extends through one slot of the device groove and then bends downwards to be in contact with the spring. Further, the wall of the battery groove are formed with two notches. A lower inner wall of the battery groove is formed with a ring. Moreover, a conduction unit can be used to replace the spring and metal cap. A sound emitting element can be used with the light emitting body.

### FIELD OF THE INVENTION

The present invention relates to touch controlled lighting emitting device; and particularly to a touch light emitting controlled device which has a simple structure and can be assembled easily so that cost so that is reduced.

### BACKGROUND OF THE INVENTION

A prior art touch controlled light emitting device includes a battery base, a battery set, a light emitting base, a light emitting body, a spring, a button, etc.

The light emitting base is located above the battery base. In assembly, the battery is placed in the battery base. Then the light emitting seat is embedded into the battery seat. When the power of the battery is exhausted, the battery seat is raised in force for updating battery. Thus the operation is tedious and inconvenient.

The prior art touch controlled lighting emitting device can be used in various tiny objects, for example, key rings, ball pens, music pens, stamps, etc. However the prior art has the following defects necessary to be improved. The molds of the light emitting base and battery base are formed separately so that the cost is high and assembled work is tedious. Moreover, to have a firmly structure, the light emitting base and battery base are engaged tightly, but in updating the battery, the operation is inconvenient since a larger force is necessary to separate the two seats.

### SUMMARY OF THE INVENTION

Accordingly, the primary object of the present invention is to provide a touch controlled lighting emitting device which comprises a base having a device groove at an upper end thereof and a hollow battery set at an lower end thereof; a light emitting body installed on the device groove having a long lead and a short lead; a battery set installed in the battery groove; a spring enclosing an periphery of the battery set and a length of the spring is larger than an expandable spring of the battery set; a metal cap in a lower end of the spring and retained with the spring with a predetermined distance. A bottom of the device groove of the base is formed with at least one through hole which is communicated with the battery groove. A wall of the device groove is formed with at least one axial slot. A wall of the battery groove is formed with at least one axial recess. Each slot is communicated with a respect recess. The short lead of the light emitting body passes through the through hole to be in contact with a top electrode of the battery set in the battery groove. The long lead extends through one slot of the device groove and then bends downwards to be in contact with the spring; further. The wall of the battery groove is formed with two notches. A lower inner wall of the battery groove is formed with a ring.

Moreover, the spring and metal cap can be replaced by a conduction unit and a sound emitting unit is usable with the light emitting body.

Another object of the present invention is to provide a touch controlled lighting emitting device which comprises a base having a device groove at an upper end thereof and a hollow battery set at an lower end thereof; a through hole being in the device groove; a light emitting body installed on the device groove having a long lead and a short lead; a battery set installed in the battery groove. A wall of the device groove is formed with at least one axial slot. A wall of the battery groove is formed with at least one axial recess. Each slot is communicated with a respect recess. The short lead of the light emitting body passes through the through hole to be in contact with a top electrode of the battery set in the battery groove. The long lead extends through one slot of the device groove and then bends downwards. Then the long lead bends to a bottom of the battery groove so as to be formed as a bending portion. The bending portion is retained with a predetermined distance with a lower electrode at a bottom of the battery set. Further, the wall of the battery groove is formed with two notches. A lower inner wall of the battery groove is formed with a ring.

The various objects and advantages of the present invention will be more readily understood from the following detailed description when read in conjunction with the appended drawing.

### BRIEF DESCRIPTION OF THE DRAWINGS

FIG. 1 is an exploded perspective view of the first embodiment of the touch controlled lighting emitting device of the present invention.

FIG. 2 is an assembled perspective view of the first embodiment of the touch controlled lighting emitting device of the present invention.

FIG. 3 is a cross section view about the base of the touch controlled lighting emitting device of the present invention.

FIG. 4 is a cross section view of the touch controlled lighting emitting device of the present invention.

FIG. 5 is a schematic view includes the lighting structure of the first embodiment of the present invention.

FIG. 6 is a schematic view about the base in the first embodiment of the present invention.

FIG. 7 is a cross section view about the base in the second embodiment of the present invention.

FIG. 8 is a cross section view about the touch controlled lighting emitting device in the second embodiment of the present invention.

FIG. 9 is an exploded view of the touch controlled lighting emitting device in the third embodiment of the present invention.

FIG. 10 is a cross section view of the touch controlled lighting emitting device of the present invention,

FIG. 11 is an exploded perspective view of the fourth embodiment of the present invention.

FIG. 12 is a cross section view about the touch controlled lighting emitting device in the fourth embodiment of the present invention.

FIG. 13 is an exploded schematic view about the fifth embodiment of the present invention.

### DETAILED DESCRIPTION OF THE PREFERRED EMBODIMENTS

First Embodiment

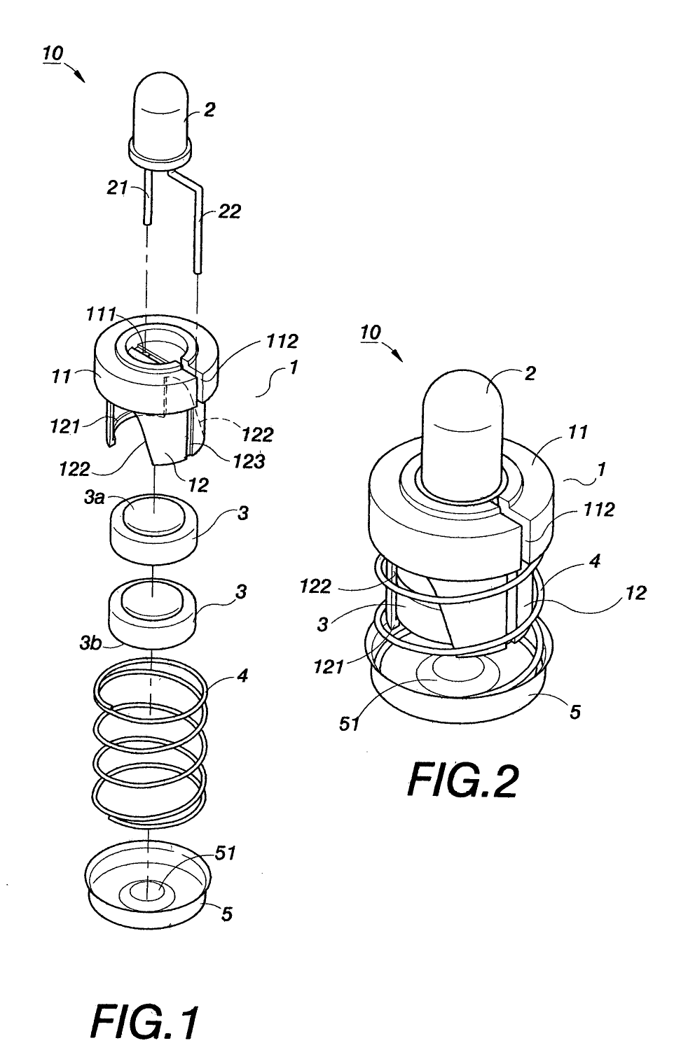

Referring to FIG. 1, the exploded perspective view of the touch controlled lighting emitting device of the present invention is illustrated. The touch controlled lighting emitting device 10 includes a base 1, a light emitting body 2, a battery set 3, spring 4, and a metal cap 5. The assembled perspective view of the touch controlled lighting emitting device is illustrated in FIG. 2.

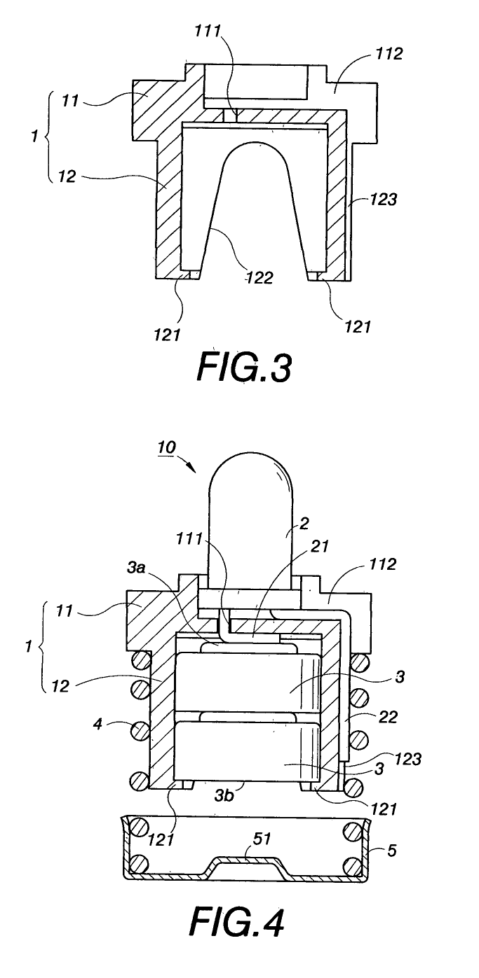

The base 1 is integrally formed by insulating materials using molding injection ad the cross section view thereof is illustrated in FIG. 3. An upper end of the base 1 is a device groove 11 and a lower end thereof is a battery groove 12. A bottom of the device groove 11 is formed with a through hole 111 which is communicated to the hollow battery groove 12. A lateral wall of the device groove 11 has an axial slot 112. The slot 112 is communicated to one end of the through hole 111. An inner lower edge of an inner wall of the battery groove 12 has a ring 121 protruded from the inner wall. Thereby, when the battery set 3 is mounted into the battery groove 12, the ring 121 will confine the battery set 3 so that the battery set 3 does not fall out. The wall of the battery groove 12 is formed with two opposite notches 122 which are opened at an lower edge of the battery groove 12. The width of each slot 112 is reduced from a lower end to an upper end thereof. Thereby, by the notches 122, the battery set 3 in the battery groove 12 can be taken out easily by expanding the wall of the battery set 3 as the user uses fingers or tools to take the battery set 3 out of the battery groove 12. An axial recess 123 is formed at an outer wall of the battery groove 12 and is exactly below the slot 112.

Referring to FIGS. 1 and 4, a whole cross section view of FIG. 4 is illustrated. It is illustrated in the drawing that the light emitting body 2 is installed in the device groove 11 in the base 1. A bottom side of the device groove 11 has a short lead 21 and a long lead 22 which are conductive. The short lead 21 passes through the through hole 111 in the bottom of the device groove 11 to the battery groove 12. The long lead 22 transversally extends from the slot 112 and then extends downwards to the recess 123 in the outer wall 123 of the battery groove 12. Thereby, the long lead 22 is positioned by the slot 112 and the recess 123.

The battery set 3 has one or a plurality of batteries which are connected in serial in the battery groove 12. The battery set 3 is confined by the ring 121 so as not to fall out. An electrode 3a on a top of the battery set 3 resists against the short lead 21 and a lower end of the battery set 3 is not in contact with any object.

The spring 4 is a metal helical spring, encloses the battery groove 12 and is in contact with the long lead 22. A top end of the spring 4 resists against a lower edge of the device groove 11 and a lower end of the spring 4 resists against the metal cap 5.

The shape of the metal cap 5 is like a basin and a center on a bottom of the metal cap 5 has an upward protruded convex portion 51. A bottom of the spring 4 resists against a peripheral concave ring of the convex portion 51. The spring 4 is expandable for buffering the metal cap 5 and serves to retain a predetermined distance between the metal cap 5 and the battery groove 12.

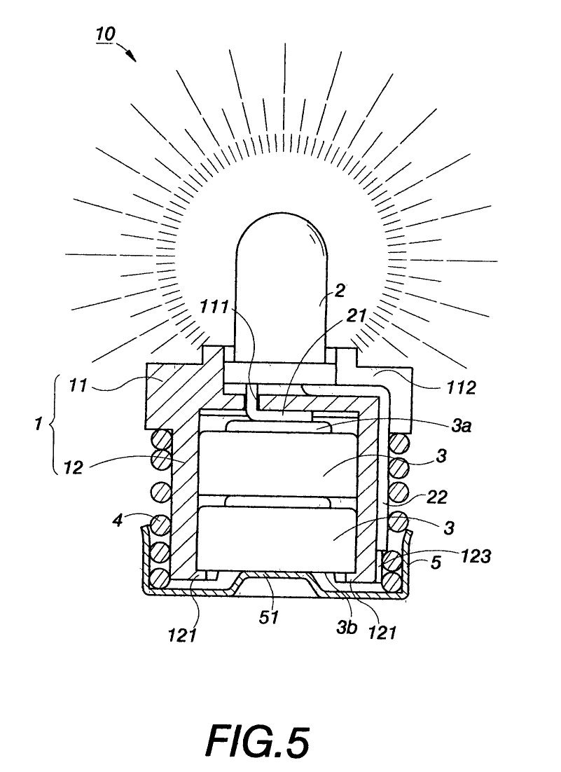

FIG. 5 is a schematic view showing the light emitting mechanism of the touch controlled lighting emitting device. When the base 1 is motionless (for example, to be fixed to a pen tube) and an outer force is applied to push the metal cap 5 to rise upwards so as to push the metal cap 5, then the convex portion 51 of the metal cap 5 contacts an electrode 3b at a bottom of the battery set 3 in the battery groove 12, the circuit will conduct and thus the light emitting body 2 lights up. Furthermore, when outer force is released (for example, the refill is not used so that the pressure from the refill is released), by the resilient effect of the spring 4, the metal cap 5 is separated from the battery groove 12 to restore the state shown in FIG. 4. Thereby, the circuit is interrupted and the light from the light emitting body 2 extinguishes.

Second Embodiment

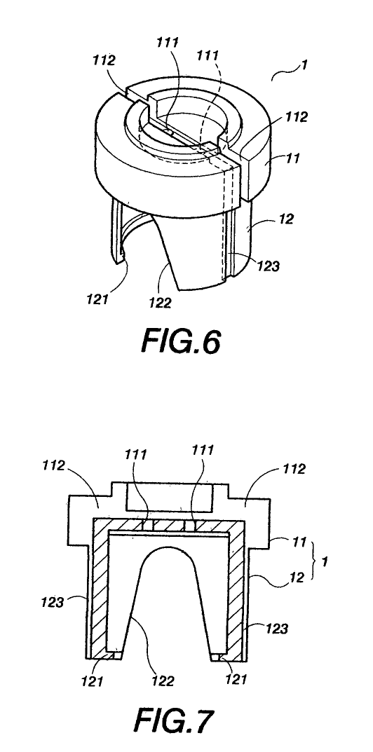

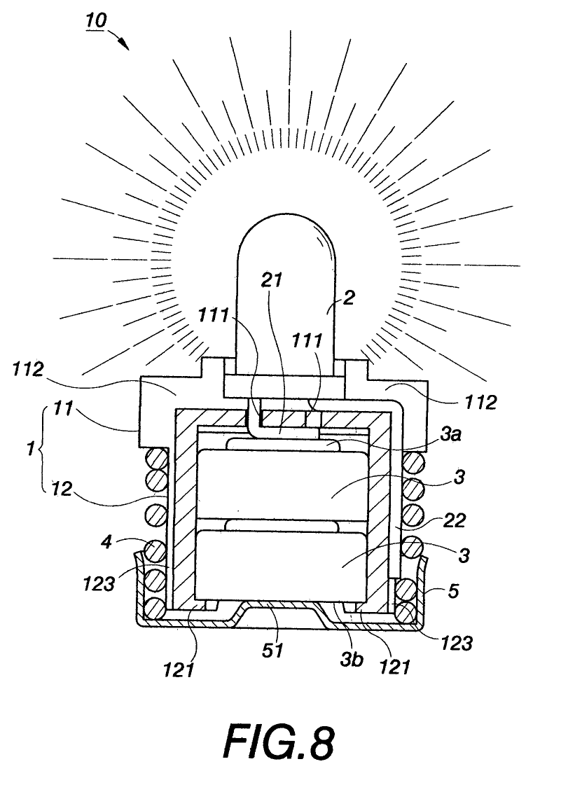

Referring to FIGS. 6 and 7, the second embodiment of the present invention is illustrated. It is shown that two through holes 111 are formed on the bottom of the device groove 11. Two symmetric opposite slots 112 are installed at the wall of the device groove 11. The two through holes 111 and the two slots 112 are at the same diameter of the device groove 11. Two recesses 123 are exactly below the two slots 112 so that the light emitting body 2 can be assembled easily since the user can identify the orientation. An assembled view is illustrated in FIG. 8.

Third Embodiment

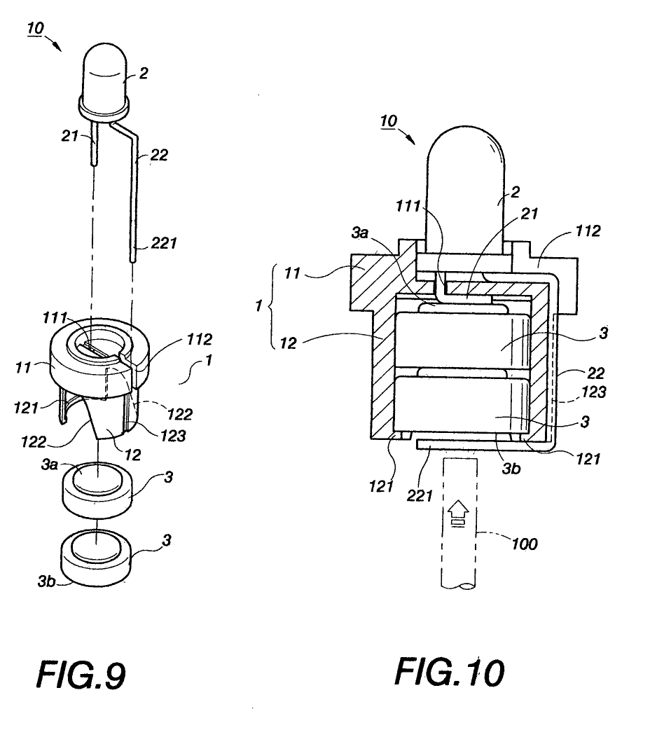

In above, the assembly of the spring 4 and metal cap 5 is described for opening and closing the circuit so as to control the lighting up of the light emitting body 2. In FIG. 9, it is illustrated that the lighting up of the light emitting body 2 is controlled without using the spring 4 and the metal cap 5. As shown in the drawings, the long lead 22 of the light emitting body 2 is longer than the former one, the long lead 22 can be bent to have a bending portion 221, as shown in FIG. 10. The long lead 22 is formed as an L shape. The bending angle of the long lead 22 resists against the bottom of the battery groove 12 and a front end of the bending portion 221 is retained with a distance to the electrode 3b of the battery set 3. The bending portion 221 is formed as a suspending arm and is elastic for replacing the spring 4 and metal cap 5. When an external object 100 (such as a refill, a post or others) ejects the bending portion 221, the bending portion 221 will contact the electrode 3b, so that the light emitting body 2 lights up. When no external force is applied to the bending portion 221, the bending portion 221 restores elastically so as to separate from the electrode 3b. Thus the circuit does not conduct and the light emitting body 2 extinguishes.

Fourth Embodiment

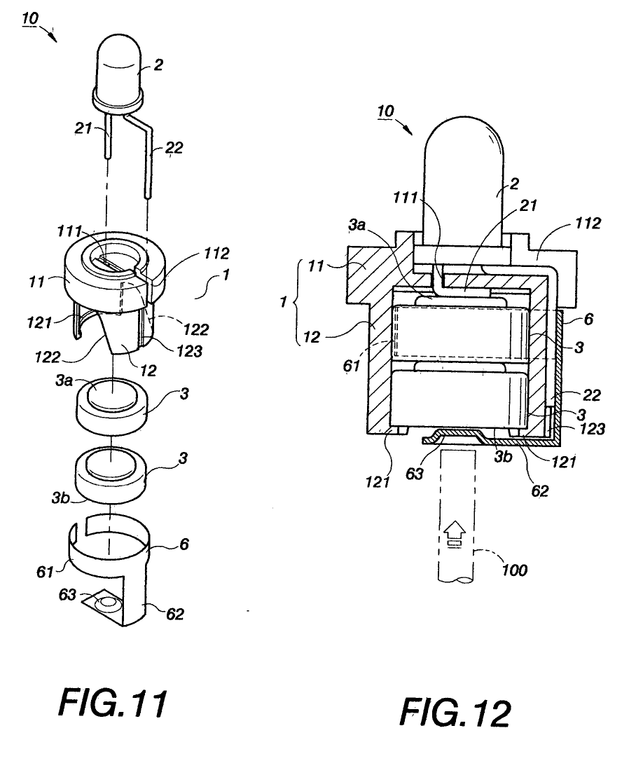

As shown in FIG. 11, it is illustrated that a conduction unit 6 is used to replace the spring 4 and metal cap 5. A top of the conduction unit 6 has a buckling ring 61. A lower edge of the buckling ring 61 extends with an L shape guide sheet 62. A horizontal section of the guide sheet 62 has a convex portion 63. The assembled view of the fourth embodiment is illustrated in FIG. 12. It is shown that the conduction unit 6 is buckle at the periphery of the battery groove 12 by the buckling ring 61. The L shape guide sheet 62 is in contact with a lateral side of the long lead 22. The horizontal section of the guide sheet 62 resists against the bottom of the battery groove 12 and the convex portion 63 of the horizontal section is retained with a predetermined distance to the electrode 3b. When an external object 100 (for example a refill, a post, or others) ejects against the horizontal section to rise upwards, the convex portion 63 moves upwards to contact the electrode 3b of the battery set 3 and a circuit of the light emitting body 2 conducts to light up. Moreover, when no external force is applied (for example, the external object 100 does not further apply any force to the horizontal section), the guide sheet 62 restores by the resilient force itself so that the convex portion 63 separates from the electrode 3b of the battery set 3. Then the light emitting body 2 extinguishes.

Furthermore, in above embodiment, the convex portion 63 can be neglected. Namely, the horizontal section can contact the electrode 3b of the battery set 3 directly to make the light emitting body 2 light up.

Fifth Embodiment

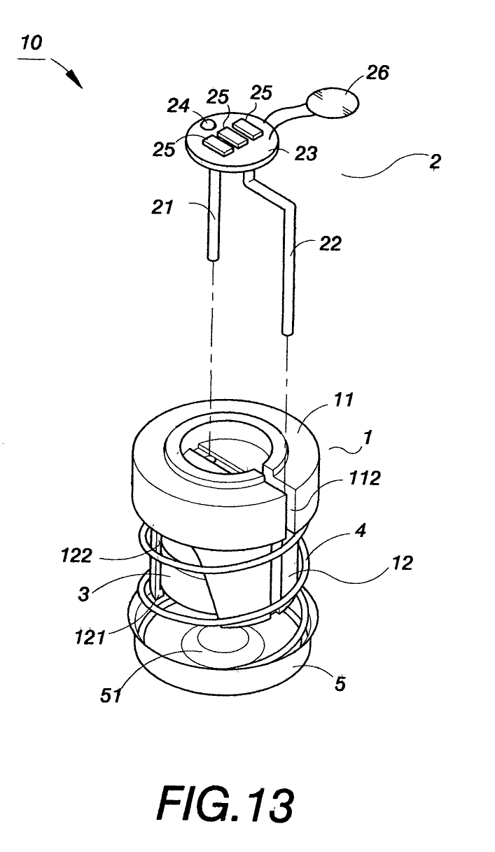

With reference to FIG. 13, another embodiment of the touch controlled lighting emitting device of the present invention is illustrated. In FIG. 13, the light emitting body 2 is an IC circuit board 23 which can be electrically controlled. The IC circuit board 23 is installed with an IC 24, and a thin light emitting element 25. By using the IC 24, the light emitting element 25 is controlled to the light up with various lighting sequence, such as flashing with single or multiple color lights, or changing light intensities, etc. Furthermore, a plurality of light emitting elements 25 can be used for changing the lighting way. For example, flashing alternatively, changing the intensity of the color, or combination of different colors.

Moreover, the light emitting element 25 can be arranged as a matrix so as to form a pattern in the IC board 25. Moreover, sound emitting elements can be installed on the IC board. For example, buzzers, vibrating reeds, trumpets, or sound emitting sheets, or others can be used. Thereby, the touch controlled lighting emitting device of the present invention is used to sound emitting elements other than light emitting body. Both sound emitting element and light emitting body can be used to the touch controlled lighting emitting device of the present invention. Moreover, other devices of different functions can be used in the present invention.

Advantages of the present invention will be described herein. The base is formed integrally. Thus the manufacturing process can be simplified so that the cost is reduced. The battery set can be directly inserted into the battery groove without using any element. The battery set can be taken out from the two recesses at two sides. Thereby, it is unnecessary to decompose the battery groove and the device groove as the prior art design. The two through holes and two slots of the device groove are at opposite sides and thus the assembly work is easy and rapidly. The orientation for assembly can be identified easily. The basin-like metal cap can clamp the spring with the base. Thereby, the touch controlled lighting emitting device is placed in an object or decoration easily.

The present invention is thus described it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A touch controlled lighting emitting device comprising:
a base having a device groove at an upper end thereof and a hollow battery set at an lower end thereof;
a light emitting body installed on the device groove having a long lead and a short lead;
a battery set installed in the battery groove;
a spring enclosing an periphery of the battery set and a length of the spring being larger than an expandable spring of the battery set;
a metal cap in a lower end of the spring and distanced from the spring with a predetermined distance;
wherein a bottom of the device groove of the base is formed with at least one through hole which is communicated with the battery groove; a wall of the device groove is formed with at least one axial slot; a wall of the battery groove is formed with at least one axial recess; each slot is communicated with a respect recess; the short lead of the light emitting body passes through the through hole to be in contact with a top electrode of the battery set in the battery groove; the long lead extends through one slot of the device groove and then bends downwards to be in contact with the spring; further, the wall of the battery groove are formed with two notches; a lower inner wall of the battery groove is formed with a ring.

2. The touch controlled lighting emitting device as claimed in claim 1, wherein there are two through holes at the bottom of the device groove; and there are two slots and two recesses which are arranged at opposite sides of the walls of the device groove and battery groove, respectively, the two through holes, two slots, two recesses are at the same diameter line of the bottom of the device groove.

3. The touch controlled lighting emitting device as claimed in claim 1, wherein the two through holes are in a radial recess at the bottom of the device groove; the long lead is embedded in the radial recess.

4. The touch controlled lighting emitting device as claimed in claim 1, wherein the light emitting body includes an IC board and an IC, and light emitting elements.

5. The touch controlled lighting emitting device as claimed in claim 1, wherein at least one sound emitting element is in the device groove.

6. A touch controlled lighting emitting device comprising:
a base having a device groove at an upper end thereof and a hollow battery set at an lower end thereof;
a sound emitting body installed on the device groove having a long lead and a short lead;
a battery set installed in the battery groove;
a spring enclosing an periphery of the battery set and a length of the spring is larger than an expandable spring of the battery set;
a metal cap in a lower end of the spring and retained with the spring with a predetermined distance;
wherein a bottom of the device groove of the base is formed with at least one through hole which is communicated with the battery groove; a wall of the device groove is formed with at least one axial slot; a wall of the battery groove is formed with at least one axial recess; each slot is communicated with a respect recess; the short lead of the light emitting body passes through the through holes to be in contact with a top electrode of the battery set in the battery groove; the long lead extends through one slot of the device groove and then bends downwards to be in contact with the spring; further, the wall of the battery groove are formed with two notches; a lower inner wall of the battery groove is formed with a ring.

7. The touch controlled lighting emitting device as claimed in claim 1, further comprising a conduction unit having the function of spring and metal cap; a top of the conduction unit having a buckling ring; a lower edge of the buckling ring extends with an L shape guide sheet; a horizontal section of the guide sheet having a convex portion; and the convex portion of the horizontal section being retained with a predetermined distance to the electrode.

8. A touch controlled lighting emitting device comprising:
a base having a device groove at an upper end thereof and a hollow battery set at an lower end thereof; a through hole being in the device groove;
a light emitting body installed on the device groove having a long lead and a short lead;
a battery set installed in the battery groove;
wherein a wall of the device groove is formed with at least one axial slot; a wall of the battery groove is formed with at least one axial recess; each slot is communicated with a respect recess; the short lead of the light emitting body passes through the through holes to be in contact with a top electrode of the battery set in the battery groove; the long lead extends through one slot of the device groove and then bends downwards, then the long lead bends to a bottom of the battery groove so as to be formed as a bending portion; the bending portion is retained with a predetermined distance with a lower electrode at a bottom of the battery set; further, the wall of the battery groove are formed with two notches; a lower inner wall of the battery groove is formed with a ring.
